(19) United States
(12) Patent Application Publication
(10) Pub. No.: US 2013/0211967 A1
(43) Pub. Date: Aug. 15, 2013

(54) Ordering and Payment Systems

(71) Applicant: Ian Charles Ogilvy, Rozelle New South Wales (AU)

(72) Inventor: Ian Charles Ogilvy, Rozelle New South Wales (AU)

(21) Appl. No.: 13/814,667

(22) PCT Filed: Aug. 8, 2011
(86) PCT No.: PCT/AU11/01006

§ 371 Date: Mar. 19, 2013

(30) Foreign Application Priority Data
Aug. 6, 2010 (AU) 2010903508

(51) Int. Cl. G06Q 30/06

(52) U.S. Cl. CPC G06Q 30/0637
USPC 705/26.82

(57) ABSTRACT

The present invention relates to a method and apparatus for processing a product transaction. An order system is provided which independently stores orders generated by a customer, in a customer order repository, A customer order repository is associated with a customer order repository ID which identifies the customer order repository. When shopping, the customer selects a product and provides the customer order repository ID to the vendor. The vendor provides the COR ID to the order processing system together with information identifying the product. The order processing system then communicates with a customer device via a customer interface, such as a client App. The customer confirms the order and the order processing system processes payment. Details of order processing and other information relating to the order may be published on social network sites and communicated to the customer and to the vendor.

### FIELD OF THE INVENTION

The present invention relates to improved ordering and payment systems for ordering and paying for products, and, particularly, but not exclusively, to improved ordering and payment systems for facilitating retailing via computer networks, ouch as the Internet.

### BACKGROUND OF THE INVENTION

Customer network retail systems are well known. Shopping on the Internet commonly involves a customer accessing a vendor website, via the customer's computing device connected to the Internet.

The customer's computing device commonly operates a browser enabling the customer computing device to be served with Web pages of a vendor site, providing information on products (which can include goods and/or services) available for sale.

Typically, the customer browses the vendor's website and selects one or more products that they would like to purchase.

Typically, when a customer wishes to select a product, the vendor's system (eg a server computing system serving Web pages) provides an ordering and payment interface to enable the customer to deal with ordering and payment.

Although there are variations on how ordering and payment then proceeds, usually the customer will have to provide details for shipping (where shipping is required) and will need to provide a form of payment before shipping occurs. Shipping details must be entered at least once for every vendor site the customer wishes to shop from and payment must be separately made for each vendor website the customer wishes to shop from.

Payment can be made by a number of available systems, including credit card, debit card, systems which deal with direct payment (eg Paypal™), and others.

Present systems are therefore quite cumbersome, in that they require the customer to separately provide details to each vendor site they wish to purchase products from. As well as ordering details (eg shipping address, etc), customers must separately provide payment details. Further, providing payment details to many vendors is insecure as it is quite possible that the payment details (eg credit card numbers) could be misappropriated.

### SUMMARY OF THE INVENTION

In accordance with a first aspect, the present invention provides a method of processing a product transaction, comprising the steps of a vendor system receiving an order notification from a customer, the order notification identifying a product available for order from the vendor, transmitting a product identifier for the product to an order system, storing the product identifier in an order repository of the order system, establishing communication between the customer and the order system, receiving order processing instructions for the product from the customer via the established communication, and transmitting a confirmation of the order for the product to the vendor system from the order system.

In an embodiment no payment information is received by the vendor system from the customer. The customer merely orders a product from the vendor system. The information for ordering of the product is then stored in the order repository. The customer can then separately review the product information stored in the order repository and provide order processing instructions to the order system if they wish to proceed with the order. In an embodiment, the order processing instructions may include payment instructions. The order system then deals with the vendor to separately confirm the order and, in an embodiment, may also confirm and deal with payment with the vendor system.

In an embodiment, this has the advantage that the vendor does not receive any payment information. Further, the customer need only deal with the order system as far as ordering and payment is concerned. The order system essentially acts as a third party dealing with order and payment processing once the customer has confirmed that they wish to proceed with an order.

In an embodiment, the same order system may be utilized for shopping from a plurality of vendor systems. The customer may therefore shop from many vendors, and product identifiers for a plurality of products from different vendors may be transmitted to the order system. The customer then separately communicates to the order system, reviews the products. The order system then separately deals with all the vendor systems to process the order (and payment, in the embodiment where payment is dealt with by the order system). This has the advantage that the customer only need deal with a single order system as far as the processing of payment and order details are concerned. They do not have to separately deal with each vendor system.

In an embodiment, the order processing instructions may include shipping details for the one or more products that may be stored in the order repository. In an embodiment, the order repository may store the shipping details for each particular customer. In an embodiment, the confirmation of the order may include providing the shipping details to the vendor system. This has the advantage that the customer need not separately provide shipping details to each vendor that they shop with. This is dealt with at a single point, being the order system. This is also an advantage to the vendor, as they need not separately deal with each individual customer (of what may be many customers of the vendor) in relation to shipping details and other order details. The vendor also benefits from the single point of contact, being the order system.

In an embodiment, the order notification includes a customer order repository identifier. This identifies a customer order repository, being part of the order repository of the order system. This can be considered to be a personal “shopping cart”, where a customer may place product orders, for later processing and review. It is known in, for example, vendor website systems, to provide a “shopping cart” where a customer places their order. The shopping cart is, however, associated with the particular vendor website. The customer order repository of this embodiment of the present invention, can be considered to be an independent “shopping cart” which is able to be utilized to receive orders from a plurality of separate independent vendor systems. This has the advantage that a customer can shop at any vendor system, using the same shopping cart. It provides one point of access for the customer to deal with ordering of products from multiple vendors. It has the further advantage, that the order system deals with all the order processing steps without requiring further input from the vendor, apart from review and approval of the product (and any amendments to the shipping address, if any) that may be required. It also has the advantage that the order system deals with all payments, without requiring further input from the customer. The customer therefore only has to provide payment details to one point, therefore advancing security. In an embodiment, the method comprises the further step of the order system receiving a customer order repository identifier. In embodiments, this and information identifying a product (which may be a physical product, a service, software or any other product) is all the information required by the order system to enable a transaction to proceed. In the embodiment, the customer order repository identifier is provided to the vendor system by the customer. In an embodiment, the vendor system merely needs to provide the customer order repository identifier, together with the product identifier, to the order system to identify the repository associated with the customer. The customer order repository may then be accessed by way of a customer device and the customer can then authorise to continue the transaction.

In an embodiment, the product identifier may be any identifier which enables identification of a product to be the subject of the transaction.

The only information that the customer needs to provide to the vendor is the customer order repository identifier, whose only function is to enable product to be placed into the customer order repository. The customer order repository identifier therefore need not be secure. It is not required to provide any secure details to any vendor. Any misappropriation of the customer order repository identifier would serve no purpose. All the misappropriator would be able to do would be to place orders in the customer order repository. The customer need not continue the transaction any further.

In an embodiment, the order processing instructions from the customer comprise providing a payment identifier to the order system. The payment identifier may be any token, such as a password, biometric, or any other token which identifies the customer and enables the order system to pay for a product from a customer account, or using customer payment means such as credit card details. In an embodiment, the order system may maintain an electronic wallet for each customer, storing customer funds to be used in payment. Payment details may remain secure as the payment identifier only needs to be known by the consumer and the order system, and does not have to be provided to any of the vendor systems.

In an embodiment, where the customer has an associated customer order repository identifier, multiple customer order repository identifiers may be provided, associated with the same customer order repository. This allows for redundancy, for example if one of the customer order repository identifiers is misappropriated, another one can be used to replace it. It also allows for multiple consumers to use the same customer order repository. For example, family members of a single family may place products in the same shopping cart (customer order repository). Payment authorization, however, may be controlled by only one or two family members who are aware of the payment identifier. For example, children in a family may be able to shop and place product orders in the repository, but only parents may be able to approve those orders for further processing and completion.

In an embodiment, the method comprises the further step of tracking the status of delivery of the order eg where the order is being shipped to the customer. In an embodiment, the order system is arranged to do this. The customer may be provided with information on status of the order.

In an embodiment, the method comprises the further step of publishing order information, comprising information relating to the order processing. The information may be any information relating to the order processing or the transaction. In an embodiment, publication may be via communication to media such as social networks. In an embodiment, publication may be on displays which may be local to a product provider location e.g. retail location.

In an embodiment, rating information may be published. Rating information, in an embodiment, is information relating to a rating that a customer or other party to in the order processing may have placed us a measure of the experience that they have had with the transaction.

In an embodiment, payment to the vendor for the order may be held in escrow until the order is delivered. In an embodiment, the order system may be associated with a trusted entity such as a financial institution, or other trusted entity. The trusted entity may guarantee payment to the vendor but may not deliver payment until the order is completed.

In accordance with a second aspect, the present invention provides an apparatus for processing a product transaction, comprising an order computing system, comprising network communications, a processor and a memory, and being arranged to receive a product identifier via the network communications, the product identifier identifying a product that a customer wishes to purchase from the vendor who is making the product available, the memory comprising an order repository arranged to store the product identifier, the network communications being arranged to establish communication between a customer computing system and the order computing system, and to receive order processing instructions from the customer computing system via the communication, the order computing system being arranged to transmit a confirmation of the order for the product, in response to receiving the order processing instructions, to a vendor computing system of the vendor.

In an embodiment, the order repository of the order computing system comprises a plurality of customer order repositories, each being associated with a respective customer. In an embodiment, the order computing system is also arranged to receive a customer order repository identifier, which identifies the customer order repository associated with the customer, and the order computing system is arranged to load a product identifier into the customer order repository associated with the received customer order repository identifier.

In accordance with a third aspect, the present invention provides a customer apparatus for processing a product transaction, the customer apparatus including a network communications facilities, a processor, a memory and a customer interface for interfacing with a customer and for facilitating message communication with the apparatus of the second aspect of the invention.

In an embodiment, the customer interface is arranged to store in the customer apparatus memory a cache of customer order repository information of a customer order repository of the apparatus.

In accordance with a fourth aspect, the present invention provide a method of facilitating dissemination of information relating to a transaction relating to a transaction for a product, comprising the step of publishing information associated with the transaction.

In accordance with a fifth aspect, the present invention provides a method of processing a product transaction, comprising the steps of a plurality of vendor systems receiving order notifications from customers, the order notifications being transmitted to a separate third party site and stored in a customer repository associated with each customer, subsequently processing the orders stored in each customer repository, by the third party site communicating with the customers and then communicating with the vendor systems in order to process the order, in response to confirmation from the customer to do so.

In accordance with a sixth aspect, the present invention provides a system for facilitating product processing, comprising an order system having a plurality of customer order repositories associated with a customer order, the customer order repositories being arranged to store product information relating to products customers wish to purchase from separate vendor systems.

In an embodiment, each of the customer order repositories is identified by a customer order repository identifier, and the system is arranged to receive customer order repository identifiers communicated by a vendor's devices and associate the customer order repository identifiers with the customer order repository.

### BRIEF DESCRIPTION OF THE DRAWINGS

Features and advantages of the present invention will become apparent from the following description of embodiments thereof, with reference to the accompanying drawing, in which:

FIG. 1 is a schematic diagram of a system in accordance with an embodiment of the present invention.

FIG. 2 is a schematic diagram illustrating how a order processing system may be utilized to provide public information relating to order processing;

FIG. 3 is a schematic diagram illustrating a system for publishing information relating to order processing, in accordance with embodiment of the present invention;

FIG. 4 is schematic illustration of an order system in accordance with an embodiment of the present invention, illustrating arrangements for publishing information relating to order processing;

FIG. 5 is a schematic illustration of an in-store display for publishing information relating to order processing;

FIG. 6A, 6B are a flow diagram illustrating a generic order process in accordance with an embodiment of the present invention;

FIG. 7 is a schematic diagram of a client App which may be hosted on a customer device; and

FIG. 8 is a schematic of a widget application that may be hosted on a customer device.

### DETAILED DESCRIPTION OF EMBODIMENTS

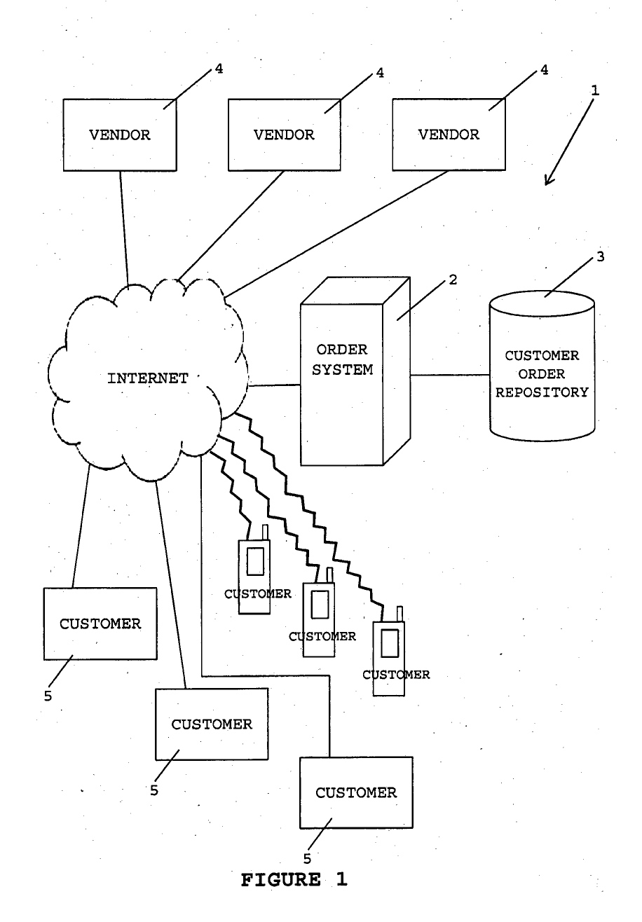

An embodiment of the present invention is illustrated in FIG. 1. It comprises an order computing system generally designated by reference numeral 1, which, in this example, comprises a server computing system 2 which includes a network communications apparatus for communicating with other computing systems connected via a network, such as the Internet 3. The order computing system 1 also comprises a memory in the form of a database 3, which comprises an order repository for storing product identifiers of products which are available for sale from vendors.

In this embodiment, the order computing system 1 is arranged to receive product identifiers of products that customers wish to purchase from vendors, and store them in the order repository database 3. The order repository 3 comprises a plurality of order repositories, each being associated with a customer. The order computer system is also arranged to receive customer order repository identifiers, which identify customer order repositories associated with each particular customer. The order computing system 1 is also arranged to communicate with customer computing systems and receive order processing instructions from customers, and then subsequently to communicate with vendor computing systems and instruct the vendors to process the orders in accordance with the order processing instructions.

In more detail, the computing system 1 in this embodiment is implemented as a server computing system 2 which may include a plurality of server computers, depending upon the capacity required. The server 2 is arranged to serve Web pages over the Internet and may also be arranged to distribute applications to remote computing devices connected to the Internet. The server 2 comprises a network communications interface which may be of known configuration. The communications interface may include a network card and/or other known communications devices for communicating with networks via wireless or wired communications.

The server 2 comprises suitable components necessary to receive, store and execute appropriate computing instructions. The components may include one or more processing units, read only memory (ROM), random access memory (RAM), and input/output devices such as the communications interface discussed above, also disk drives, Ethernet port, USB port and other input/output devices. The server may also include a display and a user interface, including a keyboard and a mouse for local input/output and administration purposes.

The database 3 may comprise any suitable storage device arranged to communicate with the server computer 2 and has memory which may include solid state drives, hard disk drives, optical drives, magnetic tape drives, RAM, ROM or any other type of memory.

The computing system 1 also comprises a bus for communications within the server 2 and between the server and database 3.

In this embodiment, the order computing system 1 is arranged to communicate via the network communications (in this embodiment the Internet), with a plurality of vendor computing systems 4 and a plurality of customer computing systems 5, 6. The vendor computing systems are associated with retail systems, for retailing product (which may be goods and/or services) available from the vendors.

The vendor computing systems may comprise any computing technology, but will generally also comprise server computers arranged to serve web pages and various applications over the Internet, so that customers can browse product information to select products available from the vendors.

In FIG. 1, only three vendor systems 4 are shown. It will be appreciated that this is an example illustration only, and that there may be many more vendor systems. In an embodiment, the order computing system 1 may be able to communicate with many vendor systems, all providing product information over the Internet. The vendor systems 4, may be typical Internet shopping systems.

Two types of customer systems 5, 6 are illustrated. Blocks 5 represent typical computing systems, which may be PCs, laptops, tablet devices or any other type of computing system including browser software or other appropriate means for browsing web pages over the Internet and/or receiving applications downloaded over the Internet. Box 6 represents mobile devices, eg PDAs, mobile telephones, tablet devices or any other devices which similarly have communications apparatus arranged to communicate with the network, browse web pages, and receive applications. A customer may use one or other type of the devices 5, 6 to communicate with the vendor systems 4 and/or the order computing system 1. In one embodiment, the customer may use one device 5 or 6 to communicate with the vendor system 4 and another device 5 or 6 to communicate with the order computing system 1.

In this embodiment, a customer, via a customer computing system 5, 6, browses information served by one or more vendor computing systems 4 in order to select and purchase products for sale.

The invention is not limited to the architecture described above for the order computing system 1. Any other alternative architecture may be used. For example, main frame/terminal architecture may be utilized. A cloud computing implementation may alternatively be utilized. Any other computer architecture implementation may be utilized.

In typical Internet shopping systems, the following steps will usually be implemented:
1. The customer system 5, 6 accesses a Web site served by vendor system 5.
2. The customer selects one or more products, adding these items to a “shopping cart” available at the vendor 4 system.
3. The customer proceeds to the “checkout” section (or equivalent) of the vendor Webpages to confirm their purchases.
4. The consumer confirms their order and, if required, provides the vendor system 4 with shipping details (eg customer's address).
5. The customer provides some form of payment eg credit card number, accessing a payment site which confirms payment with the vendor (eg Paypal™, or other type of payment).
6. When the vendor has confirmed payment the goods are shipped (the vendor may use a shipping company).

Note that steps 4 and 5 may be carried out together or may be reversed in order.

The customer therefore deals with ordering and payment at the same vendor system (the same Website in this embodiment). Some of the payment processing may be transferred to another Website (eg Paypal™) but the customer is returned to the vendor 4 system in order to complete the purchase and order.

This has a number of disadvantages:
The customer must provide secure information over the Internet to or via the vendor site 4, in the form of payment information eg credit card details, Paypal™ password, etc. This information is therefore available for misappropriation.
If a customer wants to buy products from a number of vendors, they must separately shop and order at each vendor system 4. This means they must separately provide order information (eg shipping address) and payment information at each vendor system. This is cumbersome both for customers (having to deal with many separate vendor systems 4) and for vendors (having to deal with many separate customers via their customer systems 5, 6).
The customer must deal with a different vendor system 4 each time they want to shop at a different vendor, and they may have to deal with multiple different interfaces.

Vendor systems are known which present Websites which aggregate products from a number of different merchants. An example of this is Amazon™. A customer can therefore obtain products which originated from different merchants at one site. Nevertheless, they still have to deal with payment and ordering at that one site. There is no option for them to deal directly with the merchants. Such sites are really nothing more than “computerized catalogues”.

This embodiment of the invention addresses many of the problems of typical on-line shopping discussed above, by separating the ordering of product from the vendor system and dealing with it by a single system (the order computer system 1). This provides one point of contact for ordering for the customer and the vendor. The customer may therefore shop from a plurality of vendors 4, but only deal with one order system. In this embodiment, this is achieved by providing each customer with an associated customer order repository into which they may place product information for products they may wish to order. The customer order repository is stored in database 3 of the order computing system 1. The customer order repository associated with the customer is in fact an independent “shopping cart” that is associated with the customer, and is not associated with vendor sites. The customer can therefore access a single shopping cart for products from multiple vendors. This has significant advantages for the shopping process, as will be discussed below.

In this embodiment, the database 3 is partitioned into a plurality of customer order repositories (CCR). As discussed above, these effectively act as independent shopping carts, each being associated with a customer. Customers are provided with customer order repository identification tokens, which may be any token eg number, biometric, any other identifier, or any combination of tokens. The COR ID, or “load token” identifies the customer's COR to order computing system 1. In this embodiment, to initiate an order, the customer browses and selects the product and provide the load token to the vendor system. The vendor system can then deal with the order computing system to continue the transaction. The customer does not need to be involved directly with the vendor system again, in order to complete the transaction.

The COR is able to be loaded with information, such as product information on products that a customer may wish to purchase. A customer can then access their COR and confirm to the order computer system 1 whether they wish to complete the order for the product. In this embodiment, if the customer confirms that they do wish to complete an order, the order computing system 1 then separately communicates with each vendor computing system and confirms the order, and may provide shipping information and any other information required for completion of the order.

One example shopping process using the system of this embodiment, is as follows:
1. Using their customer device 5, 6, a customer shops at one or more vendor systems 4.
2. They select products that they may wish to buy, from the one or more vendor systems 4.
3. They provide each vendor site 4 with their COR ID.
4. Information on the product, including the product identifier and COR 10 is then sent to the order computing system 1 and is stored in the COR identified by the COR ID. The product information may be transmitted directly from the vendor system 4 to the order computing system or may go via the customer computing system 5, 6. It may be transmitted in any other way.
5. In an embodiment, the vendor system 4 has information which enables it to transmit information to the order computing system 1. In an embodiment the “payment page” of a vendor website 4 may include an option for entering the COR ID to be transmitted to the order computing system 1,
6. Separately a communication is established between the order computing system 1 and the customer computer 5, 6. The communication may be established by the customer computer 5, 6, or it may be initiated by the order computing system 1 (eg calling up the customer device 5, 6). The connection may be permanently available, in the alternative, when the customer computer is on and “logged in” to the order computing system 1 and alerts may appear when product information is loaded into the COR ID. In one embodiment, an interface for the customer device 5 may be provided as a client “App”. The client App may be hosted on a customer device such as a customer mobile device, for example. An open socket connection is provided between the order computing system 1 and the client App. Alerts and other processing messages may be provided between the App and the order computing system 1.
7. The customer reviews contents of the COR presented by the order computing system 1. They determine whether or not they wish to proceed with order of the product.
8. If they do wish to proceed with ordering of a product, they confirm the order.
9. The order computing system subsequently deals with the vendor, by communicating with the vendor system 4, to confirm the order. This may include providing the vendor with shipping information, if the product is to be shipped. The vendor system 4 therefore does not deal with the order until it receives confirmation from the order computing system.

In this embodiment, the process also includes the step of the customer confirming with the order computing system that payment may be made. The order computing system 1, as well as storing a COR for each customer, also stores payment details eg credit card number, other payment details (eg Paypal™) and/or it may store a wallet which the customer can access and provide with funds from time to time. Payment is therefore dealt with via the order computing system 1, and secure payment information does not need to be provided to the vendor 4. In embodiments, the order computer system 1 may confirm to the vendor 4 that payment has been made and will be delivered to the vendor (eg by delivering it to a vendor account).

This system has a number of advantages:
A customer need only become familiar with a single order interface ie the order interface provided by the order computing system. They do not have to become familiar with multiple different vendor interfaces.
The customer only needs to deal with one point of call to process orders for all shopping with all vendors.
Payment details are retained securely and the user need only deal with one system for payment.
A customer may reserve a product by placing it in their shopping cart (COR). Because they then separately access the order computer system 1 to process the order, this allows for a “cooling off” period. If the customer decides not to complete the order, then nothing further will take place and the product will not be ordered or paid for.
The only information associated with the customer that need be provided to the vendor systems 4 is the COR ID (load token). If this is misappropriated, it does not matter. All this allows someone to do is to place products in a customer's COR and not process the orders or pay for the products.

These and other advantages will become clear from the following examples.

### Example 1

1. Consumer visits web site of vendor online store served by a vendor system 4.
2. Consumer selects one or more items, adding these items to the online shopping carte available at the vendor site.
3. consumer proceeds to ‘check out’ at the vendor site to confirm online purchases
4. consumer may
a) login to store web site to retrieve payment methods and delivery details and then use current details or modify current details as required. This is appropriate where a load token for the consumer is already saved in the login details for this site
b) enter directly payment and delivery details using a load token as the payment method. Ideally the site/step 4 has been modified to allow ‘payment’ to proceed without shipping details if preferred.
   5. a) the vendor web site server submits the details of the transaction to the personal shopping carte order system 1 server including all details necessary for the identification of the proposed transaction in addition to the customers ‘load token’ COR ID so that details may be loaded directly into the customers shopping cart (COR). In this method the entire order appears in the personal carte as a single item
Or
b) vendor web site transfers details of purchase, including individual items purchase to independent shopping carte/payment web site generated by order system 1. Details of purchase include sufficient details so that order can be re-presented to vendor site from shopping carte web site. Customer identifier for 3rd party shopping system (possibly held in the ‘credit card’ field on vendor web site) may be sent in transferred information of this value can be picked up from web browser ‘cookie’ system. If consumer identifier is known to vendor web site then web browser control need not be transferred to 3rd party shopping carte (order system 1)
   6) In one alternative the consumer may be transferred to the shopping cart website generated by the order system 1. This will result in a webpage (or other interface) for the personal shopping carte being displayed either in the original window, or in a new window.
a) ‘check out’ and place order immediately, order is submitted by shopping carte web site server system (order system 1) to vendor server and result is displayed to customer. Customer may elect to be continue transacting on the vendor web site but this is not necessary
or
b) order is held in 3rd party shopping carte for later processing at a time of the customers choosing. Customer may elect to continue transacting on the vendor web site but this is not necessary. In either case a) or b), the customer may pay at the shopping cart site (order system 1) using their secure payment information.
or
c) an independent program on the computing device (5, 6) used to place the order is either manually activated or triggered and launched automatically allowing optional confirmation and placement of order from 3rd part shopping carte web servers 1
or
d) and independent program on a different computing device (5, 6) is either manually activated or triggered and launched automatically allowing optional confirmation and placement of from 3rd party shopping cart servers 1.

In either c or d the original web shopping site page may be arranged to display the transaction status, updating as the independent program completes the transaction.

The system and method of the present invention will allow the option of a customer using a secure device for the payment and order processing step. That is they may use one device (for example a PC 5) to shop with vendor systems 4 and place product information in their shopping cart (COR). They may then use another device, eg a mobile device 6, to communicate with the order computer system 1 and confirm the order and make the payment. Using a separate device further increases security.

The method and process of the present invention is not limited to implementation and shopping over networks, such as the internet. Shopping may occur over any network, intranet or extranet. But other types of shopping may be implemented using aspects of this system and process, including ordering over a communication device such as a telephone device and also shopping at point of sale (POS).

### Example 2

### Telephone Order Style Based Purchase

1. Consumer phones merchant representative. Provided merchant is registered with the improved 3rd party shopping carte system 1, payment can be facilitated through this system.
2. merchant representative enters purchase details to ‘order placement portal’ section of the website improved 3rd party website or through other provided application.
3. Consumer quotes ‘load token’ (COR ID) identification and merchant enters this detail together with other transaction details to improved 3rd party website/application portal
4. consumer either load application or website for their account or application is opened automatically on consumers phone/computer in response to a trigger sent from improved 3rd party shopping carte application
5. consumer approves or declines transaction

### Example 3

### Retail Point of Sale Purchase

1. Consumer visits physical store and chooses items to purchase. At payment phase, consumer offers a physical medium (card, smart card, proximity card, near field device) which communicates an identification of a ‘load token’ (COR ID) to merchant representative.
2. merchant representative enters purchase details via point of sale device and those details are sent to ‘order placement portal’ servers 1 for processing
3. consumer either load application or website for their account or application is opened automatically on consumers phone/computer in response to a trigger sent from improved 3rd party shopping carte application 1.
4. consumer approves or declines transaction
5. if approved by consumer, point of sale at store prints receipt or otherwise displays result to merchant and goods are given to consumer

### Example 4

### Order Confirmation Client

For web transactions, normally a web browser will be used for selecting items to be purchased from the vendor store web site. At the point where the ‘pay with improved 3rd party shopping carte’ or equivalent button is pressed and the order is sent to the 3rd party shopping carte servers 1, the server will reply to the merchant server with status information for the web browser.

These instructions to the web browser may to launch the order confirmation client as a web 2.0 or other application within the web browser, simply to display a message instructing the consumer to confirm the transaction on their order confirmation client.

The order confirmation client may be a web application as described above, or alternatively where possible, a dedicated program already running on a computing device owned by the consumer/shopper. As a dedicated program, as opposed to a web client, communicates only with the 3rd party shopping carte eliminating ‘spoofing’ where one web site pretends to be another is prevented and also a dedicated application allows custom security measures. As a dedicated program, saved data can also be used to improve the user experience.

This dedicated application may be automatically launched whenever the chosen computing device is on and the consumer is logged in. The ‘passive mode’, is the normal state the application will automatically start in and also the mode the order confirmation client will operate in when the consumer is not actively interacting with the system. In this ‘passive mode’ the client will communicate with the 3rd party shopping carte servers by, for example, opening a socket and sending a login and possibly periodic heartbeat messages. In passive mode, the application can run in the background or as a ‘desktop widget’ with a semi-background display.

This enables the 3rd party shopping carte system to know the client is running and be able to contact the client and launch the client to ‘active mode’ automatically when the 3rd party shopping carte system adds new items to the consumers shopping carte.

As the 3rd party shopping carte system 1 can be aware of the running or not-running status of the order confirmation client the response to merchant store systems can allow appropriate display on a web browser to instruct the consumer. In the preferred scenario as the client would be already running in ‘passive’ mode when the items are loaded into the carte the web browser display can simply suggest refreshing the browser after confirming the order, as the client will automatically display the order for confirmation allowing any order which the consumer desires to proceed without delay simply requires easy and seamless confirmation.

As discussed above, the client may be provided as an App on a customer device. In this embodiment, the App has an open socket connection to the order computing system 1. Alerts may be provided via the App when orders are placed in the customer order repository. Via the App, the customer can then communicate with the order computing system 1 to continue processing the transaction. Updates of status of the order may be provided via the App. The App can “run in the background” so it is always available to receive/send messages with the order system. Push notifications can therefore be provided from the order system.

The App (or a similar interface on the customer device) can also provide facility to cache information on the customer device. In one embodiment, the shopping carte ordering information is cached on the device so that if the connection to the order system 1 is not available, the customer can still review orders that have previous been placed in their shopping carte and take action, awaiting communication to be re-established.

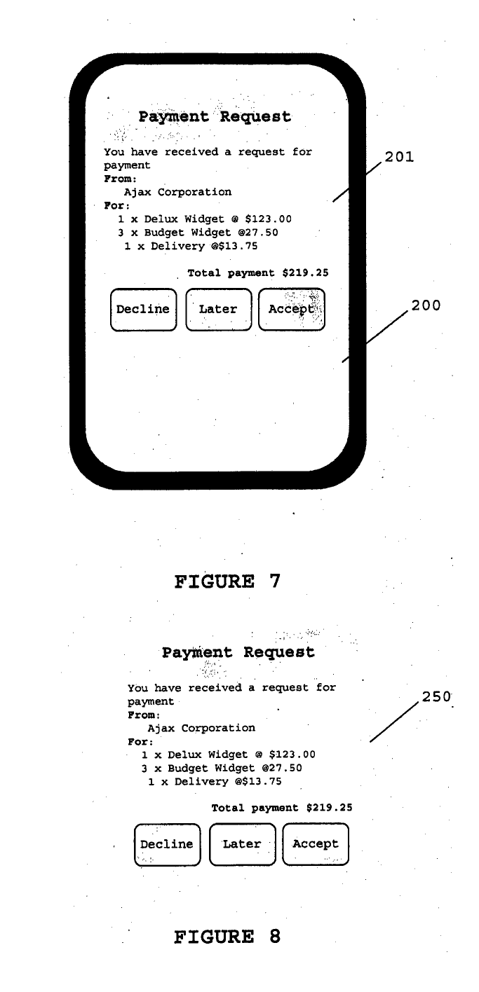

FIG. 7 is a representation of a mobile customer device screen 200, illustrating how an App may display 201 information on an order.

The App remains “waiting” on the device until a request for payment is received from the order system 1. The customer is presented with a screen detailing who the payment is to and what it is for. The customer has the opportunity to accept, decline or leave for later. The customer may be asked to enter a password depending on the rules they have set up (e.g. only ask for password if the transaction is over a particular amount of money).

The customer interface may be in another form than an App. FIG. 8 illustrates a customer interface in the form of a “widget” 250 that may be provided to a computer display such as a laptop, PC or tablet device.

### Example 5

### Presentation of Order to Vendor Web Site

In several scenarios where the invention is used for a consumer to make purchases, an order is displayed for approval on a device to be used by the consumer for approval of the transaction (e.g. via a client App on the customer's device).

In these cases the order may need to be ‘refreshed’. That is, the order resent to the vendor web/site or servers for verification that any change to circumstances have occurred. Possible changes include:
1) the time is now outside a window for which the order was held for this consumer
2) the delivery details of the consumer are now known or altered

Should a ‘refresh’ of the order be necessary under either of these guidelines, the order is resent to merchant web/site or servers as a verification order and to obtain a new valid ‘time period’, and any changed pricing which may now apply.

If the order is within the valid time period and the delivery details for the consumer are unchanged then the consumer may confirm and order in which case payment is processed and the order using the details of all items together with confirmation of payment are then sent to the merchant web site/or servers for processing. The merchant web site/servers will respond indicating the success of the transaction, projected timing for fulfillment and delivery process and tracking number in use.

A “validation period” is allowed in embodiments, which is a period for which the product information in the shopping cart remains valid. If the customer purchases (ie, completes the order) in this period, then the price and other information on the product will not change. If the customer does not complete the order during the validation period, however, then before completion the order may need to be revalidated by the vendor system 4 and/or varied (eg as to price).

Embodiments of the present invention may have the following features.

### Security

Embodiments of current invention provides for even remote transactions to be secured to a level beyond that possible even with current retail point of sale transactions. Existing ‘prior art’ systems actually provide a far lower level of security for online an other remote (e.g. phone) transactions than is possible at the retail point of sale.

### Purse/Wallet

The account holder of the 3rd party shopping carte may have funds loaded from credit cards, bank accounts or transferred from other accounts. These funds can be used to make micro payments or simply for general purchases. Funds held in the shopping carte can be ‘topped’ up from linked any linked account either on a ‘just in time’ ready for the next purchase or at any time the account holder desires.

### Carte Loading Tokens

Each account on the 3rd party shopping system will normally have a single login/authentication system for placing orders, but may have multiple ‘load tokens’ (long numeric/alphanumeric codes which identify an account for the purpose of loading items into the shopping carte). This means that if a ‘load token’ is compromised and things are being added to the carte that the account owner wishes, a new token can be generated and an old one deleted. Alternatively, new tokens can be creamed for specific purposes, and any number of active tokens can exist at one time.

Special tokens can even be created to allow recurrent orders to be processed and to allow them to be controlled by the account owner, instead of blindly re-occurring even when the account owner no longer wishes.

A web or other online interface can display a list of all ‘active’ tokens and, for recurrent payment tokens, the rules that apply to those tokens.

Several tokens (CORIDs) may be associated with a single shopping basket. That is, for example, several customers may shop and place information in the same shopping basket. Members of a family, for example, Payment authorization may be only be enabled for some of the customers, however. For example, in a family, only the parents may be able to pay and therefore further process the orders. This would allow them to see what their children are placing in the shopping basket and decide whether or not these items should be purchased.

The present system is different from prior art systems, which usually deal with ordering of product, provision of delivery details and payment processing in a series of consecutive steps, usually dealt with by one system. In the present embodiment, ordering is dealt with totally separately. Indeed ordering may be carried out via a separate customer device and the other steps in the transaction (provision of delivery details, confirmation of order and payment) may be carried out by a completely separate device (or the same device) of the customer. Particularly, once the customer has placed the order, the customer then deals with the order system, and does not need to deal further with the vendor, except perhaps via the order system. The order system therefore sits in between the vendor and the customer, and is able to be controlled by the customer so that the customer can interact to complete the transaction or vary the transaction and confirm payment and delivery. The customer may communicate live, “real time” with the order system in order to complete a transaction. For example, if a user is at point of sale (POS) they may place the order via the POS system (providing the load token by RFID or giving the load token to a customer service operative). Via the client App (Or other interface) on their mobile device, the customer may then completely control the rest of the transaction process, via the order system.

The order system can be used for all types of transaction. It is not limited to on-line transactions, but can be used for point of sale transaction, transaction by the telephone, transactions face to face, or any other method of implementing a transaction. The load token is provided to the vendor, and then the customer can control the rest of the process via the order system.

The ability for the customer to interact with the order system, allows a capability of the order system to provide information to the customer to be exploited. In embodiments of the present invention, the order system is arranged to monitor the progress of an order by communication with the vendor system. It can determine, for example, where an order is placed in a “queue” and can provide updates to the customer of the status of their order. The status of order fulfillment may also be monitored. For example, where a product must be prepared, such as a complex product like a bicycle that needs to be built, status information can be provided by way of the customer interface.

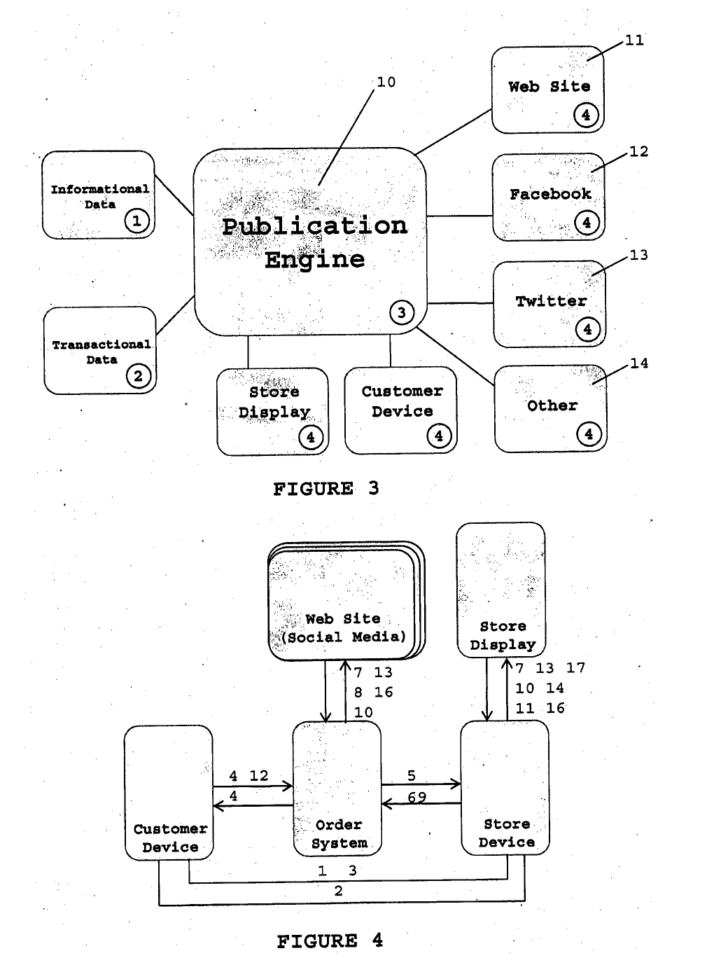

In an embodiment, information associated with the transaction may be published. It may be published via the order system communicating the information to be published over network sites such as social media, for example, or to “store displays” or onto any webpage. For example, a web page associated with the vendor may publish information relating to transactions. This could be any information. It may include information on ratings provided by customers, rating their experience with the vendor and/or the order system. The rating of an experience by customers is often used by other potential customers to decide whether or not to use a particular vendor and therefore is a valid form of advertising. FIG. 3 is a schematic diagram of an embodiment of the present invention where information associated with a transaction or a vendor or a customer who deal with the order processing system 1, is published.

In this embodiment, the order computing system 1 includes a publication engine 10. This may be in the form of the order system server 2 or may be provided by any convenient architecture. Utilizing the memory of the order system 2 publication engine may receive and store information for publication. It may then generate feeds to web and social media sites based on the information received, so that the information may be published. Publication engine 10 may feed to websites 11, social pages 12, continuous information feeds sites such as “Twitter™” 13 and to other 14 publication sites.

Information may be provided from vendors associated with the order system 2 and the customers associated with the customer order system 2. Information for publication may also be generated from transactional data 16 relating to transactions that have been carried out via the order system 2.

Customer or vendor can therefore enter information onto a single system and the system can automatically generate multiple representations of information for publication. In one embodiment, a vendor may enter information into the order system 2 and publication engine 10 is arranged to automatically generate an account for the vendor, a website for the vendor, a Facebook™ page for the vendor and a Twitter™ account for the vendor, and provide information to one or all of these.

The information may include but is not limited to a representation of the consumer, a representation of the store, a representation of the goods or services, the title of the transaction, the location of the transaction, and events.

The format and content of each publication to each site or device triggered by a unique event may be different according to the site or device that the information is being published to.
The multiplicity of web sites or other services may or may not be generated from a single site.
The identification of the customer (where published) may be a representation of the customer, for example a nickname.
Customer can select representation by store which may be different to users own representation. (ie: different nickname for pub as different to cafe as different to consumers own site)
The customer representation can be changed by time or location.
The customer representation may be anonymous by store or time or location.
The extended information may automatically be generated when a transaction event is generated.
There may be multiple events for publication incorporated in one transaction. (eg: coffee is being made, consumer is enjoying coffee)
Events may either append or update the published data
Extended information may include product and other information (Eg; John is enjoying a cappuccino and a muffin at Cafe Roma) or (Joe is preparing Macca's flat white right now) (Mary has just received her new iPad)
A Queueing system may trigger events.

Another site 14 where information may be published may be a local display associated with a vendor, such as an in store display. The information may also be published to the customer's device e.g. a client App. FIG. 5 shows an example of how a display local to a store such as a cafe may operate. The display is connected to the vendor in store system e.g. vendor computing system which processes orders and is arranged to communicate with the order system 1.
There may be multiple displays at any one store
The local display may be a highly visible display such as a television or monitor
A representation 20 of a transaction may be automatically published to the local display 21
The representation of the transaction may be displayed in such a way as to indicate the customer's position in a queue.
The representation of the transaction may be updated as events occur to the transaction for example “coffee is being made”, “coffee is ready for pick-up”
The representation of the transaction may display an estimated time to the fulfilment of the transaction 22.
The local display may display advertising or other information on part 24 of the display
There is an opportunity to charge advertisers for space on the informational display.
There is a possibility for the advertising revenue to cover the cost of the local display

Information may also be published to the customer device.
The publication may contain more personal information which may be kept on the system, for example “your selection contains traces of nuts” if the consumer is allergic, or your selection contains XXX calories, if the consumer is watching their weight.
The publication may contain financial information that is not published to other systems or devices.

Where the production of a product (“product” includes “services”) is wholly or partially automated, events within the production process may be used as events to trigger publication.

For example a pizza store may be arranged such that as the pizza progresses in the manufacturing process events can be triggered at various points in the process and published such as “your order has been received”, “your pizza is being made”, “your pizza is in the oven”, “your pizza is being delivered”.

For example, where an order for a coffee is sent directly to a barista screen and the barista indicates that they have completed the order by touching the screen or a button, that event can be published to the customer and other media.

In some cases workflow events may be triggered by the elapse of a certain amount of time.

Conversely, the system itself can be used to create a workflow for a store that does not have a workflow system or automated manufacturing process in place.

In one embodiment multiple store devices could be used to link trigger events and initiate a manual or automated process based on the trigger event. For example where a customer places a complex order comprising an entree, main course and dessert the system could trigger an event to start making the main course a pre-defined time after the entree is served.

The order system of this embodiment may implement a queue management system, when a customer queues at a store to order and pay for goods it may be viewed that they enter two serial queues. The first queue, while they wait to order and pay for their goods or services is known at the “cashier queue” the second queue whilst they wait for as their goods or services to be prepared is known as the “preparation queue”. The point of transition from the cashier queue to the preparation queue is that point when the order is placed with the store.

It is highly probable that at certain stores there will be a combination of physical (people standing in a line) and virtual (orders that have been submitted electronically) queues. Some stores may choose to give priority to the physical or the virtual orders but other stores may wish to implement a “fair” system which combines the physical and virtual queues in such a way that a virtual order is placed in the queue as though the orderer was standing in line.

The customer may identify them self to the system by one of various methods such as, using a mobile phone to place an order in the order system, using a card to order and provide a load token to store vendor system) or telling a store employee (giving employee load token and then employee communicates with order system via vendor system).

There are several ways to calculate when a virtual order should be inserted into the preparation queue.

In one embodiment the store owner may merely estimate the time taken in the cashier queue, enter it into the system and all virtual orders will be delayed by that amount of time.

In another embodiment the rate of orders being processed in the physical queue could be measured by the physical order taking device, such as a point of sale terminal, and used to calculate the speed of the queue and therefore the delay required to hold virtual orders.

In another embodiment visual or object recognition systems could be used to count the number of people in a queue and the speed of the queue could be calculated.

In another embodiment both the rate of orders at the order taking device and the visual recognition systems could be combined to calculate an accurate model of the queue.

In one embodiment, once the order of the customer in the physical queue has been entered into the system and that order information is made available to the queueing system, then all of the orders in the production queue can be published or displayed on an in store display whether they came from the physical or virtual cashier queue.

In one embodiment, customers in the physical cashier queue may be required to join the virtual queue for example, by taking a numbered ticket from an electronic device which at that point enters the physical customer in the virtual queue. This allows both the physical and virtual queues to be published or displayed on an in store display.

A customer in the virtual cashier queue may change their order up until the point that their order is transferred to the production queue.

The transition from the cashier queue to the production queue may or may not require a confirmation from the customer in the virtual queue.

Customers may generate ratings, relating to an experience with the vendor, order system or any other associated experience. These ratings may also be published.

The ratings may be entered via the customer interface, such as an App on a mobile device. An App may be arranged such that when the user wishes to exit the App they are required to press one of a number of keys according to their satisfaction with the transaction.

For example the number keys 1,2,3,4,5 on a keypad may allow the customer to rate their satisfaction with the transaction with 5 representing most satisfied and 1 representing least satisfied.

For example an application on a phone may be arranged such that when the user wishes to exit the application they are presented with a list of terms to describe their level of satisfaction with the transaction. The list of terms may be displayed from a database of synonyms for each rating level. The customer can choose to regenerate the list of synonyms from the database or they can enter their own synonym which, after vetting for appropriateness, may in turn be entered into the database of publicly available synonyms.

In thio way the system may develop a language and feel of it's own, which may contribute to the viral nature of the system.

The rating may be provided in any other way. When a customer rates a transaction, that rating generates an event in the transaction flow and can be published similarly to any other event.

The rating can be represented by a term associated with the rating for example if a customer rates a transaction 5 then the event may be published as “customer was delighted with their product from store” whereas if the customer rates the transaction with a 1 then the event may be published as “customer was disappointed with their product from store”.

The terms for the ratings may be changed, by store, for example.

In order to avoid repetition and to make the publications varied and more interesting, there may be a number of synonyms for each rating that may be published. For example a rating of 5 may be described variously as “delighted”, “ecstatic”, “elated” or “overjoyed”. With the synonym being placed syntactically correctly within the publication.

This information is especially useful for a merchant as it provides feedback as to which products are being rated well by their customers and more importantly which products are not.

When a customer rates a transaction, that rating can be used to calculate a suggested gratuity based on a set of rules determined by the customer.

For example, if a customer rates a transaction 5 then the customer may have associated a 20% tip whereas if the customer rates the transaction with a 1 then the customer may have associated a 0% tip. The tip may be added to the as transaction and proceed via the order system.

Other calculations can also be made, for example round up the tip to the nearest dollar or round up the entire payment including the tip to the nearest ten dollars.

The calculation may be displayed as a suggestion to the customer.

The customer can override the suggestion if they wish The calculation can be different for different classes of stores. For example a rating of 5 may represent a 10% tip at a cafe but represent a 20% tip at a restaurant.

When a customer rates a transaction, the rating may also be linked to the products in the transaction. For example when a customer orders a hamburger and rates the transaction 5 then it may be extrapolated that the customer's rating of the hamburger from that store is a 5.

Further, standard products such as a can of soft drink can be assumed to not effect the rating of the transaction. For example, if a transaction that includes a hamburger and a soft drink is given a rating of 5, it can be assumed that the rating of 5 is based on the hamburger alone, as the can of soft drink is essentially the same across all stores.

Products may be linked to a generic product. For example one store may name their hamburger “The Deluxe Burger” whilst another store may name their hamburger “The Big Burger” however they can both be linked to the generic product hamburger.

Once products are linked to a generic product, then it is possible to develop statistical data based on multiple customer's satisfaction with a particular generic product. For example the average rating of all customers who had a hamburger at a particular store was 4. This data becomes valuable over time as it can provide customers with comparative ratings by store by product and allows for such marketing statements as “store has the best hamburger in Sydney”

FIG. 4 shows a schematic diagram of the system in accordance with the present invention, showing flow of information. The order system 2 is arranged to process orders and communicates with the customer device 5. Communications my include status of order updates, information published by a merchant, information on queue tracking and other information and messages. FIG. 5 also illustrates the vendor device, which may be an in store device or a computer associated with a website, merchant or other system. Communications occur between the ordering system 1 and the store device relating to the transaction also relating to published information, and queue status and order status information. In-store display 21 may be provided where the vendor is associated with a store. Other types of display may be utilized depending upon the type of vendor. For example, an on-line vendor may display information associated with the transaction on its website.

As discussed above, information may be distributed over networks to be published at other sites 11, 12, 13, 14, such as social media.

Messages may be anything to do with order processing, or anything to do with any published information, that the order system, the customer or the vendor wishes to publish.

The following as an example of order flow and information that may be published and status information provided to the customer.

1. The customer shops by logging on to a website or obtaining a menu from an actual physical store. In this embodiment, the customer shops directly with the store, the store providing the menu to the customer or the merchant website providing information to the customer via browser. The load token is provided to the vendor device, by the customer, and the vendor device provides the load token and overall order information to the order system.
1. Customer requests menu from store
2. Store offers menu
3. Customer accepts offer and places order
4. Payment is processed
5. Order is sent to store
6. Store acknowledges order
7. Message “‘customer’ has just ordered ‘product’ from ‘store’ ” is published
8. Publishing site (twitter, facebook, web site) publishes message
9. Store creates event “‘product’ is ready”
10. Message “‘customers’ ‘product’ from ‘store’ is ready” is published
11. Publishing site (twitter, facebook, web site) publishes message
12. Customer rates their satisfaction by closing application using number key
13. Message “‘customers’ is ‘very’ satisfied with ‘product’ from ‘store’ is published
14. Publishing site (twitter, facebook, web site) publishes message
15. Server re-calculates satisfaction statistics
16. Message “‘x’ % of customers are ‘very’ satisfied with ‘product’ from ‘store’ is published
17. Publishing site (twitter, facebook, web site) publishes message
   Events may include store activity, such as the progress of the manufacture
   The Queueing system may also be utilised once the customer has identified them self to the system.
   A customer device (e.g. NFI card) may be used to provide load token to a store based device such as a terminal, kiosk or web site.
   In an embodiment the carte may also provide customer identity information to the system for publication and the carte may also facilitate rating of the transaction (requiring customer input).

The following are further examples of the type of information that may be published and exchanged between the order system 1, vendor device, customer devices 5 and sites where information is published.

### Example

### Where a Store Enters Information

A store owner/vendor or representative can visit a single web site, associated with the order system, and enter relatively static information such as the store name, address, phone number, map details, store description, headline, and photos, further the store owner or representative can enter more dynamic data such as a menu of products or services and associated information such as price and description.

Once the store owner or representative is satisfied with the information they can choose to publish the information. A representation of the information will then be published to a plurality of selected sites with the representation of the information being modified for each site according to a set of rules in order for the representation of the information to be appropriate for the given site.

For example a store may enter their static and menu information into the order system site and this may then be available to customers via the order system. Static information and menu headings may be published to a “yellow pages” type site and only the name and headline published to twitter.

Any changes to information can be re-published in a similar fashion.

### Example

### Where a Customer Buys a Coffee

A customer (Jane) uses the App on her phone to request a menu from a store, the store menu is downloaded to the phone and the customer selects a cappuccino and a blueberry muffin. The customer shops directly with the store and provides the load token, and the store then sends the order to the ordering system. Once the customer approves the order, instructions for filling the order are then sent from the ordering system to the store device.

This process can trigger a series of events according to how the system has been set up, for example:
A message is sent from the server to the customer's own twitter site according to the twitter API saying “Jane has just ordered a Cappuccino and Blueberry Muffin from Cafe Roma”

In the above description of the publication of information, publication of information is associated with an ordering process in accordance with an embodiment of the present invention, where the customer shops with a vendor and provides an order token to the vendor. The vendor then provides the order token and product information to the order system, and the order system then communicates with the customer device, for the customer to approve the order and continue the transaction.

In another embodiment, publication of information is not limited to an ordering system such as in the first embodiment of the invention. Publication of information may be associated with any ordering and payment system. It may be associated with a conventional on-line or POS or other ordering system, for example.

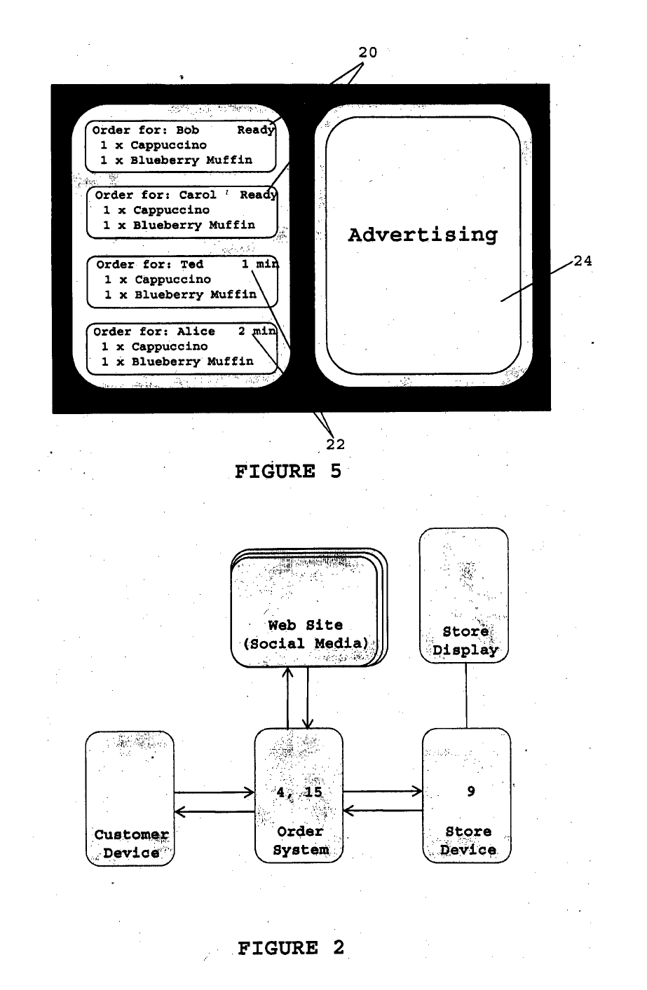

In an embodiment, published information may be generated in relation to a payment and ordering system in accordance with the applications earlier International (PCT) Patent Application No. PCT/AU2005/000902. The content of this document are hereby incorporated herein. The system in accordance with the applicant's earlier invention is illustrated in FIG. 2. In this earlier embodiment, the customer device shops directly with the order system. The store download menus to the order system so that the customer device can go to the order system for one point shopping.

Published information can be associated with this process, in a similar manner to the process of the earlier embodiment of the invention.

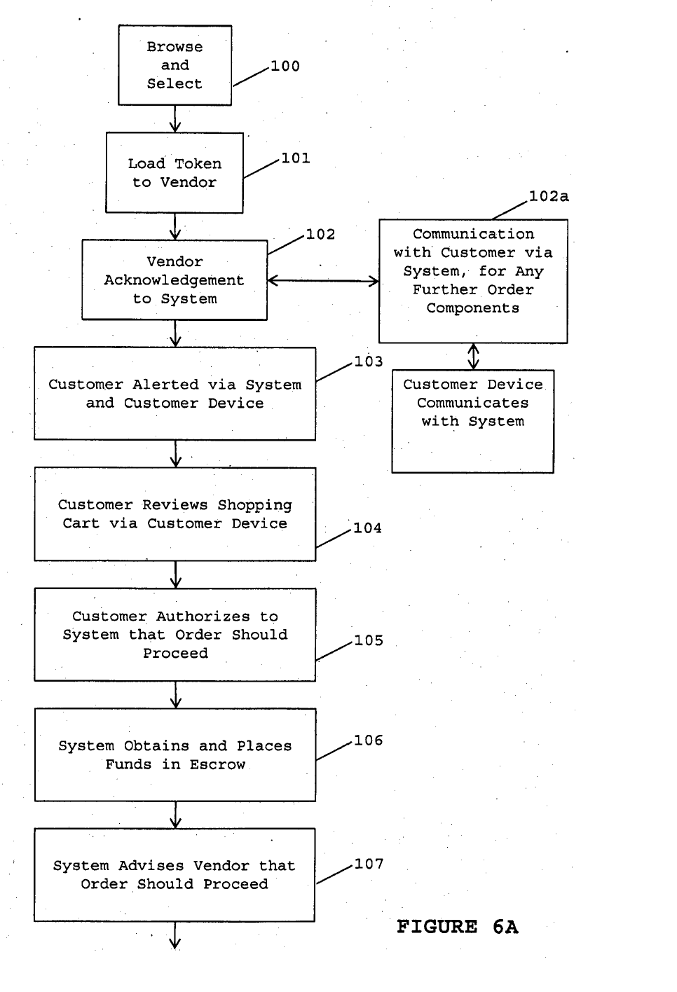

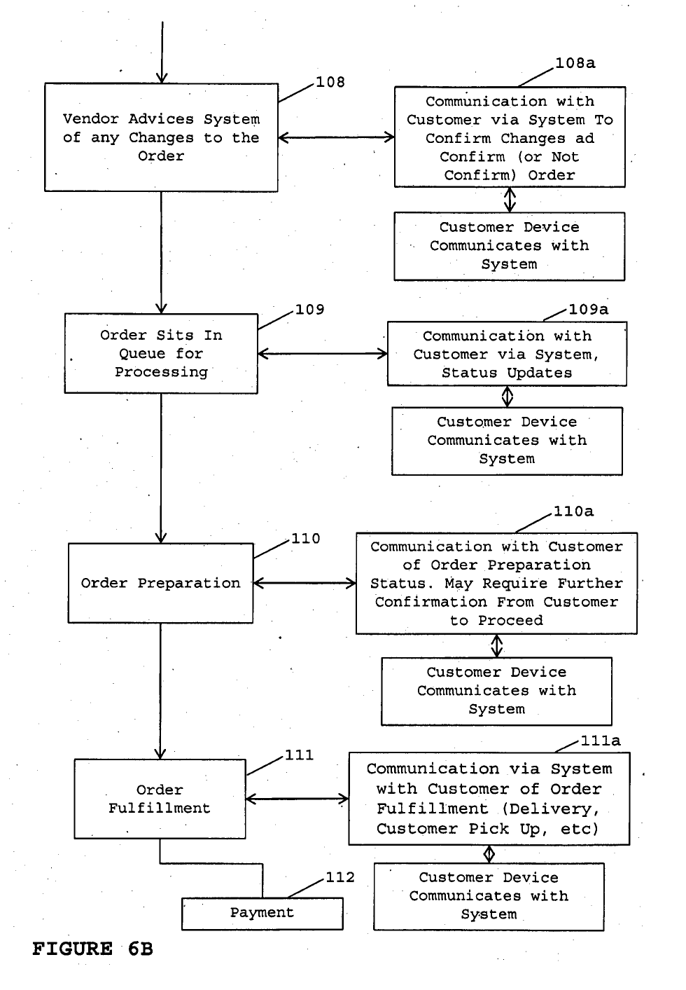

FIGS. 6A and 6B is a flow diagram illustrating a general shopping process in accordance with an embodiment of the present invention, where a load token is provided to a vendor. In this embodiment, the customer device 5 is a mobile device having a client App arranged to provide an interface with the order system 1.

Step 100, the customer shops by browsing and selecting products for purchase. As discussed above, shopping on-line, over the telephone, or by attendance at a retail store or in any other way.

In step 101, the customer provide the selection information (e.g. information on product) and the load token to the merchant. How this is done will depend upon the type of shopping which is occurring. On-line shopping will involve the information and the load token being downloaded/entered on-line. For example, the load token could be entered in a field made a field made available on a vendor website.

Where the shopping is at a store location the information and load token may be provided to a store operative. Alternatively, any information may be entered on the customer device to be transmitted to a vendor device (e.g. vendor computing system) associated with the store. In an embodiment, the load token may be stored in a device, such as a NFI card and can be downloaded to a store computing system by wireless, RFID or the like to the store computing system via a reader.

Step 102, the merchant/vendor system receives the order and acknowledges the order by communication with the order system 1. It will send the load token and the product information to the order system 1. Step 102A, the vendor may request any extra information that may be required to fill the order. For example, the customer may not have provided any information on shipping cost. The vendor communicates via the order system 1 with the customer (e.g. via the client App on the customer mobile device) to communicate the shipping cost and receive confirmation from the customer. The customer may wish to modify the order before confirming it, done by further communication between the order system 1, vendor and customer.

Step 103, the consumer reviews the shopping basket via their client App (or other interface). The consumer may be alerted via the App that there is information in their carte requiring processing.

Step 104, the consumer authorizes to the order system 1 that it wishes to proceed with the order. At this stage the consumer has the opportunity to vary any component of the order (step 105). Once authorization is received by the order System 1, the order system 1 can process and confirm the order to the vendor.

Step 106, after the order system has received confirmation of the order from the customer, the order system 1 obtains funds from the customer (e.g. where the customer has a wallet with the system, for example) and places the funds in escrow. The customer may need to top up their wallet with the order system or provide funds from an account.

Step 107, the order system 1 confirms the order to the vendor system and also confirms that money is held in escrow. Note that in an alternative embodiment money may be provided to the vendor account. In this embodiment, however, the funds are held in escrow until the order is fulfilled.

Step 108, the vendor system acknowledges to the order system that the order had been received and will be processed. At this stage there may be another opportunity for the vendor to vary the order (108A). For example, the product may no longer be available (since the initial order by the customer and the final confirmation things may have changed) or the cost of the product may be different or other changes may have occurred. The vendor may further communicate with the order system and via the order system 1 to the customer advising of changes in the order. This will give the customer another opportunity to reconfirm or not, or make any other change to the order.

Step 109, the order sits in a queue for processing by the vendor. Step 109A updates on the queue (e.g. place in the queue) and updates on the processing may be sent by the order system to the consumer.

Once the order has reached the head of the queue, at step 110 the order preparation phase commences. For example, if the product is coffee the vendor may start making the coffee. Step 110A allows for update on all the preparation to be sent to the customer via the order system. If a complex product, for example, it may take some time to prepare e.g. building a bicycle. Notification of progress can be sent to the customer via the order system 1. Step 111 the vendor system signals via the order system 1 to the customer that the order is ready. This may require another confirmation step 111A from the customer confirming that they still want the product. Obviously whether a customer can opt out at this stage will depend on vendor conditions. If the product has been prepared to the customers satisfaction it is unlikely that the vendor would allow opt out without payment at this stage.

At step 111, the product is presented for collection e.g. at a vendor premises (collection via customer, on-line, by mail). Step 111A collection could require a trigger such as a customer identifier via RFID, wireless or NFI.

At step 112, the order system 1 provides payment to the vendor, where the payment has been held in escrow by the system.

An advantage of the order system which allows this type processing to take place, is that the order system sits in between the vendor and the customer, and provides communications to the customer regarding order status and other information associated with the order. This allows the customer time to decide whether they wish to proceed and also versatility, and allows the order to be changed. The order system which essentially operates as a “policemen” standing in between the vendor and the customer. It also provides a single common uniform interface which the customer easily becomes familiar with. The customer can perform all their shopping via the order system.

As discussed above, any information associated with the order including the status of the order, content of the order, or any other information can be published.

Also as discussed above, any rating provided by the customer can also be published.

In an embodiment, ratings are weighted according to purchase profile. The order system makes a profile because it is able to monitor purchases by customers. The weighting can therefore depend upon what the purchase profile is like.

The order system 1, in an embodiment may also be able to calculate a customer status. For particular vendors, for example, where the customer shops a lot they may get a status which allows them privileges e.g. “gold, silver or bronze” status. This will depend upon conditions such as how much they shop at the store. The status updates can be determined by the order system 1, because it provides a single conduit via which orders between vendors and customers are processed. It is therefore a good place to monitor for purchasing and determining status.

As discussed above, the customer device includes an interface for interfacing with the order system 1. This may be a widget (e.g. on a PC or laptop) or by mobile. It may be a client App or any other interface. In an embodiment, the customer interface has the capacity to store data. Where in connection with the order system is not available, therefore, for example, the customer may still browse a shopping carte shopping list or browse other stored information.

“Load tokens” can also be used to identify not only recurrent payment to be made, but also recurrent payment to be received. Account holders may transfer funds to other account holder using either single or redcurrant payments to other account holders. This allows for a “child” account to receive a weekly or monthly allowance—or alternatively one of allowances—from a parent account.

A parent account can also be enabled to approve individual purchases from a child account, allowing making payments for specific items and providing a level of control where this is desired.

Items in the carte, but not yet purchased can be held in “shopping lists”. These shopping lists can contain items under consideration for purchase. A customer benefit of this supplier independent carte is that it is not necessary that this information is revealed to any suppliers. However, these lists can actually be shared with potential gift buyers much like a wedding list. Items can be purchased by friends, and either shipped to friends address or to the owner of the shopping list, depending on the desire to personally present the gift. Items purchased from the list can be marked to avoid duplicate purchases but may not reveal who the purchaser is.

Orders placed with merchants should return details of the shipping company and the tracking number supplied by the shipping company. These details allow all orders placed by a customer to be traceable through the one central place in form of the web interface or application provided by the improved third party shopping.

As orders are actually placed by the order system on behalf of the consumer, and delivery racking details are also provided, the potential exists to effectively provide and escrow system where although the consumer is charged when the order is placed, the funds are held in trust until either the order is actually shipped or even until the projected or actual delivery date. Many stores on the internet take orders for items that they do not actually hold in stock. Assurance of payment is required before these stores can in turn place orders with their suppliers. However, the financial incentive exists to such merchants to process orders slowly as under prior art systems they already hold the customers money from the time the customer placed the order. In practice, if a sufficiently large amount of orders are held there can be the temptation for the supplier to simply close and keep the funds here for orders not yet fulfilled. This risk only applies with merchants or stores with insufficient established reputation such that the value of the reputation is greater than the funds held but it remains a risk for consumers. An escrow system for selected merchants can allow enabling merchants who would otherwise be considered too risky.

In several scenarios where an embodiment is used for a consumer to make purchases, an order is displayed for approval on a device to be used by the consumer for approval of the transaction.

In these cases the order may need to be “refreshed”. That is, the order resent to the merchant web/site or servers for verification that any change to circumstances have occurred, Possible changes includes:

1. the time is now outside the window for which the order was held for this consumer
2. the delivery details of the consumer are now known or altered

Should a “refresh” of the order be necessary under either of these guidelines, the order is resent to the merchant web/site or servers as a verification order and to obtain a new valid “time period”, and any changed pricing which may now apply.

If the order is within the valid time period and the delivery details for the consumer are unchanged then the consumer may confirm and order in which case payment is processed and the order using the details of all items together with confirmation of payment are sent to the merchant web site/or servers for processing.

The merchant web site/servers will respond indicating the success of the transaction, projected timing for fulfillment and delivery process and tracking number in use.

As discussed above, the load token may be stored on a device such as an NFI card or the customer's device (so that it can be picked up by wireless, for example). The load token may be also associated directly with customer, biometric such as a fingerprint.

In addition to the previous discussion of transactions initiated to the shopping cart by either web surfing, mobile ordering, phone orders, store data entry etc.

Another embodiment relates to initiating items to be ordered being triggered to load into the shopping cart as a result of a physical action by the consumer, either touching, or bringing into close contact, or ‘pointing’ either the consumers own body, by way of for example a finger, or using an apparatus to point, touch or initiate close contact. Such an apparatus could be a mobile phone or tablet or special purpose pointing or touching or near contact apparatus.

This occurs when a consumer device is arranged to be able to detect close proximity to an identifier. Such an identifier could be a bar code which can be detected and ‘read’ by a phones camera or, or even a distinct object being able to be recognised from the image captured by the camera, or, in a preferred embodiment, a ‘tag’ which can be ‘read’ by short range radio as used in near field communications, or any other method allowing the detection of pointing, touching or near touching.

The act of pointing, touching or near touching, brings together an identifier (load token) of the consumer, either by finger print or capacitive communication or, in a preferred embodiment, by identity information held in a device arranged for the pointing touching or near touching, together with an identity of an item to be examined and then possibly loaded into the third party shopping cart, together with the identity of the ‘vendor’ or store offering the item for sale.

The identity of the item to be purchased or considered for purchase may be determined by a characteristic of the item itself, (e.g. image recognition, bar code reading, reading an id-tag) or by determining sufficiently accurately the location being indicated. Eg. id-tag placed in location of fridge door

The identity of the store or vendor of the item for sale may be obtained as an integral part of the product or item descriptor or location, or obtained by determining by a separate location selection process by and using this information either directly, or via a look up system to determine the store or vendor.

### EXAMPLES

1) rf-id tag identifies shelf and location on shelf of item together with providing the identity of the store
2) a wifi equipped mobile phone sends list and identifiers of wifi networks detected to a look up server to use this information to identify store or item vendor
3) accurate GPS or other location system data is sent by mobile device to a look up server (order system 1) to determine the identity of the store

The identity of the item for purchase may be accompanied by descriptive and pricing information sufficient for a transaction, or may be used to message a system with the identify information and store information and retrieve product description and pricing information.

For example, product selected in is fridge shelf two column 3 . . . either - - - display on fridge confirms purchase and customer opens door and picks up item - - - as above with either automatic door unlocking and or item selected identification by either image or location with alert if incorrect item is selected.

Communications between the order system, vendor system and the customer device may be any conventional communications, e.g. SSL over HTTP.
It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-32. (canceled)

33. A method of processing a product transaction, comprising the steps of:
an order computing system receiving from one vendor's computing system a product identifier for a product associated with an order notification provided by a customer to the vendor's computing system;
the order computing system receiving from another vendor's computing system another product identifier for another product associated with an order notification provided by the customer to the another vendor's computing system;
the order system having a memory storing a plurality of customer order repositories associated with a respective plurality of customers, including a customer order repository associated with the customer;
storing the product identifier and the another product identifier in the customer order repository associated with the customer;
establishing communication between the customer and the order computing system;
receiving order processing instructions for the product and the another product from the customer via the established communication; and
transmitting a confirmation of the orders for the product and the another product to the respective vendor's systems from the order system;
wherein the order system is a third party system separate from the vendor's system.

34. A method in accordance with claim 33, comprising the further step of the order system receiving a customer order repository identifier, which is arranged to identify the customer order identifier associated with the customer, from the vendor's system and the another vendor's system, having been provided with the customer order repository identifier by the customer, whereby enabling the product identifier for the product to be placed in the customer order repository associated with the customer order repository identifier.

35. A method in accordance with claim 33, comprising the step of providing a plurality of customer order repository identifiers for the customer order repository.

36. A method in accordance with claim 35, comprising the step of displaying to the customer, the orders associated with each of the respective customer order repository identifiers.

37. A method in accordance with claim 33, comprising the further step of the order system obtaining funds for payment of the order.

38. A method in accordance with claim 36, wherein the step of the order system obtaining funds comprises the step of the order system placing the funds in escrow.

39. A method in accordance with claim 33, comprising the further step of communicating status updates on the status of the order.

40. A method in accordance with claim 39, wherein the step of communicating the status updates, comprises the step of providing status update of a position of the order within an order queue.

41. A method in accordance with claim 39, wherein the step of transmitting status updates comprises the step of providing a status update of status of the preparation of a product.

42. A method in accordance with claim 33, comprising the further step of publishing information associated with the order.

43. A method in accordance with claim 42, wherein the step of publication comprises the step of publishing information on network sites, such as social network sites.

44. A method in accordance with claim 42, wherein the step of publishing comprises the step of publishing information on an in-store display associated with a retail environment.

45. An apparatus for processing a product transaction, comprising:
an order computing system, comprising network communications;
a processor and a memory, and being arranged to receive a product identifier via the network communications;
the product identifier identifying a product that a customer wishes to purchase from a vendor who is making the product available and being arranged to receive another product identifier via the network communications;
the another product identifier identifying a product that a customer wishes to purchase from another vendor who is making the another product available;
the memory storing a plurality of customer order repositories associated with a respective plurality of customers, including a customer order repository associated with the customer, the customer order repository associated with the customer being arranged to store the product identifier and the another product identifier;
the network communications being arranged to establish communication between a customer computing system and the order computing system, and to receive order processing instructions from the customer computing system via the communication;
the order computing system being arranged to transmit a confirmation of the order for the product and the another product, in response to receiving the order processing instructions, to respective vendor computing systems of the vendor and the anther vendor; and
the order computing system being a third party order computing system separate from the respective vendor computing systems.

46. An apparatus in accordance with claim 45, wherein the order computing system is arranged to receive a customer order repository identifier, identifying the customer order repository associated with the customer and match the customer order repository identifier with the customer order repository.

47. An apparatus in accordance with claim 45, wherein the order computing system is arranged to receive the customer order repository identifier from the vendor's computing system.

48. An apparatus in accordance with claim 45, further comprising a wallet arrangement, arranged to store funds associated with customers.

49. An apparatus in accordance with claim 45, wherein the order computing system is arranged to communicate status updates on the status of the order, to customer devices.

50. An apparatus in accordance with claim 45, the order computing system being arranged to publish information associated with the order.

51. An apparatus in accordance with claim 50, wherein the order computing system is arranged to communicate the publications of information so that the information is published on network site, such as social networks.

52. An apparatus in accordance with claim 50, wherein the order computing system is arranged to publish the published information on an in-store display associated with a retail environment.

53. A customer apparatus for processing a product transaction, the customer apparatus including a network communications facility, a processor, a memory and a customer interface for interfacing with a customer and for facilitating message communication with the apparatus of claim 45.

54. A customer apparatus in accordance with claim 53, the customer interface being arranged to store in the customer apparatus memory a cache of customer order repository information of a customer order repository.

55. A customer apparatus in accordance with claim 53, the customer interface being arranged to open when the customer apparatus is on and receive or transmit messages from or to the apparatus.

56. A method of processing an on-line product transaction, comprising the steps of a plurality of separate vendor sites receiving order notifications from customers, the order notifications being transmitted to a separate third party site and stored in a customer repository associated with each customer, subsequently processing the orders stored in each customer repository, by the third party site communicating with the customers and then communicating with the separate vendor sites in order to process the orders, in response to confirmation from the customer to do so.
